(19) United States
(12) Patent Application Publication
(10) Pub. No.: US 2026/0063895 A1
(43) Pub. Date: Mar. 5, 2026

(54) VISUAL OPTICAL SYSTEM

(71) Applicant: Zhejiang Sunny Optics Co., Ltd, Yuyao City (CN)

(72) Inventors: Xiaobin Zhang, Yuyao City (CN); Lin Huang, Yuyao City (CN); Yinfang Jin, Yuyao City (CN)

(21) Appl. No.: 18/979,550

(22) Filed: Dec. 12, 2024

(30) Foreign Application Priority Data
Aug. 29, 2024 (CN) 202411203389.X

(51) Int. Cl. G02B 27/00; G02B 3/00; G02B 5/30

(52) U.S. Cl. CPC G02B 27/0093; G02B 3/0043; G02B 5/3025; G02B 2003/0093

(57) ABSTRACT

A visual optical system is provided. The visual optical system includes a first optical system and a second optical system. The first optical system includes, sequentially from the first side to the second side along a first optical axis, a reflective polarizing element, a quarter wave plate, and a positive first lens piece. The second optical system includes, sequentially from the first side to the second side along a second optical axis, a positive first lens and a second lens. A radius of curvature R1m of the first-side surface of the first lens piece, a radius of curvature R2m of the second-side surface of the first lens piece, a combined focal length f12e of the first lens and the second lens, and a distance TDe on the second optical axis from a first-side surface of the first lens to a second-side surface of the second lens satisfy: 0.8<(R1m/R2m)/(f12e/TDe)<2.0.

### CROSS-REFERENCE TO RELATED APPLICATIONS

This application claims the priority from Chinese Patent Application No. 202411203389.X, filed in the National Intellectual Property Administration (CNIPA) on Aug. 29, 2024, the contents of which are hereby incorporated by reference in their entirety.

### TECHNICAL FIELD

The present disclosure relates to the field of optical devices, in particular to a visual optical system.

### BACKGROUND

With the continuous development of mixed reality technology, visual optical systems having an eye-tracking function are becoming more and more important. The visual optical systems having an eye-tracking function are important components of mixed reality apparatuses, which may capture pupil information, locate individual information, and ensure information safety. However, these visual optical systems having an eye-tracking function usually have problems such as a relatively long total body length, heavy weight, or a forward-located center of gravity, which affect user experience.

### SUMMARY

In a first aspect, implementations of the present disclosure provide a visual optical system, including: a first optical system and a second optical system sequentially from a first side to a second side. The first optical system includes, sequentially from the first side to the second side along a first optical axis, a reflective polarizing element, a quarter wave plate and a first lens piece; where, the first lens piece has a positive refractive power, a first-side surface of the first lens piece is a concave surface, and a second-side surface of the first lens piece is a convex surface. The second optical system includes, sequentially from the first side to the second side along a second optical axis, a first lens having a positive refractive power and a second lens having a refractive power; where, a first-side surface of the second lens is a concave surface. The number of lenses having refractive powers in the second optical system is two. A radius of curvature R1m of the first-side surface of the first lens piece, a radius of curvature R2m of the second-side surface of the first lens piece, a combined focal length f12e of the first lens and the second lens, and a distance TDe on the second optical axis from a first-side surface of the first lens to a second-side surface of the second lens satisfy: 0.8<(R1m/R2m)/(f12e/TDe)<2.0.

In an implementation of the present disclosure, a center thickness CT2e of the second lens on the second optical axis and a radius of curvature R3e of the first-side surface of the second lens satisfy: −1.25<CT2e/R3e<−0.15.

In an implementation of the present disclosure, an effective focal length f1e of the first lens and an effective focal length f2e of the second lens satisfy: −1.1≤(f1e+f2e)/(f1e−f2e)≤2.0.

In an implementation of the present disclosure, a radius of curvature R1e of the first-side surface of the first lens and a radius of curvature R2e of a second-side surface of the first lens satisfy: −1.95<(R1e−R2e)/(R1e+R2e)<1.05.

In an implementation of the present disclosure, an effective focal length f1e of the first lens and a radius of curvature R1e of the first-side surface of the first lens satisfy: 0<f1e/|R1e|<1.8.

In an implementation of the present disclosure, a total effective focal length f of the visual optical system, a refractive index N1e of the first lens, and a refractive index N1m of the first lens piece satisfy: 0.5 mm<f×(N1e/N1m)<0.75 mm.

In an implementation of the present disclosure, a center thickness CT1m of the first lens piece on the first optical axis, a center thickness CTR of the reflective polarizing element on the first optical axis, a center thickness CTQ of the quarter wave plate on the first optical axis, and a total effective focal length f of the visual optical system satisfy: 18.85<(CT1m+CTR+CTQ)/f<24.4.

In an implementation of the present disclosure, a total effective focal length f of the visual optical system and the effective focal length f1e of the first lens satisfy: 0.15<f/f1e<1.35.

In an implementation of the present disclosure, the combined focal length f12e of the first lens and the second lens, a combined focal length fzm of the reflective polarizing element, the quarter wave plate and the first lens piece, and the radius of curvature R2m of the second-side surface of the first lens piece, satisfy: −4.25 mm<f12e×(fzm/R2m)<−3.25 mm.

In an implementation of the present disclosure, the combined focal length f12e of the first lens and the second lens, an effective focal length f1m of the first lens piece, and a center thickness CT1m of the first lens piece on the first optical axis, satisfy: 12.3 mm<f12e×(f1m/CT1m)<15.95 mm.

In an implementation of the present disclosure, a center thickness CT1e of the first lens on the second optical axis, the center thickness CT2e of the second lens on the second optical axis, and a total effective focal length f of the visual optical system, satisfy: 0.45<(CT1e+CT2e)/f<1.35.

In an implementation of the present disclosure, a total effective focal length f of the visual optical system, an Abbe number V2e of the second lens, and an Abbe number V1e of the first lens, satisfy: 0.5 mm<f×(V2e/V1e)<0.7 mm.

In an implementation of the present disclosure, the distance TDe on the second optical axis from the first-side surface of the first lens to the second-side surface of the second lens, a center thickness CTR of the reflective polarizing element on the first optical axis, and a center thickness CTQ of the quarter wave plate on the first optical axis, satisfy: 1.8<TDe/(CTR+CTQ)<4.45.

In an implementation of the present disclosure, the combined focal length f12e of the first lens and the second lens, and a center thickness CTQ of the quarter wave plate on the first optical axis, satisfy: 5.65<f12e/CTQ<7.4.

In an implementation of the present disclosure, an angle θ between the second optical axis and the first optical axis satisfies: 0°<θ<90°.

The visual optical system provided in implementations of the present disclosure is configured in the form of a structure combining the first optical system and the second optical system, where the first optical system includes the first lens piece, the reflective polarizing element and the quarter wave plate, and the second optical system includes two lenses and is a macro system. The second optical system has a large range of depth of field, and by disposing the first optical system on the first side of the second optical system, it is conducive to reducing the loss of overall optical performance of the visual optical system. In addition, by constraining (R1m/R2m)/(f12e/TDe) within a reasonable range, it allows for a small radius of curvature of the first-side surface of the first lens piece, which is conducive to reducing the size of the image plane of the first optical system; at the same time, it may enable the second optical system to have a small total length, reduce the volume of the second optical system, which is conducive to the combination and assembly of the second optical system with the first optical system.

### BRIEF DESCRIPTION OF THE DRAWINGS

By reading detailed descriptions of non-limiting embodiments given with reference to the following accompanying drawings, other features, objectives and advantages of the present disclosure will become more apparent. In which:

FIG. 1 illustrates a schematic structural diagram of a visual optical system according to Embodiment 1 of the present disclosure;

FIG. 2 illustrates a schematic structural diagram of a second optical system according to Embodiment 1 of the present disclosure;

FIG. 3 illustrates a modulation transfer function curve of the visual optical system according to Embodiment 1 of the present disclosure;

FIG. 4 illustrates a schematic structural diagram of a visual optical system according to Embodiment 2 of the present disclosure;

FIG. 5 illustrates a schematic structural diagram of a second optical system according to Embodiment 2 of the present disclosure;

FIG. 6 illustrates a modulation transfer function curve of the visual optical system according to Embodiment 2 of the present disclosure;

FIG. 7 illustrates a schematic structural diagram of a visual optical system according to Embodiment 3 of the present disclosure;

FIG. 8 illustrates a schematic structural diagram of a second optical system according to Embodiment 3 of the present disclosure;

FIG. 9 illustrates a modulation transfer function curve of the visual optical system according to Embodiment 3 of the present disclosure;

FIG. 10 illustrates a schematic structural diagram of a visual optical system according to Embodiment 4 of the present disclosure;

FIG. 11 illustrates a schematic structural diagram of a second optical system according to Embodiment 4 of the present disclosure;

FIG. 12 illustrates a modulation transfer function curve of the visual optical system according to Embodiment 4 of the present disclosure;

FIG. 13 illustrates a schematic structural diagram of a visual optical system according to Embodiment 5 of the present disclosure;

FIG. 14 illustrates a schematic structural diagram of a second optical system according to Embodiment 5 of the present disclosure; and

FIG. 15 illustrates a modulation transfer function curve of the visual optical system according to Embodiment 5 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens/first lens element discussed below may also be referred to as the second lens/second lens element or the third lens/third lens element without departing from the teachings of the present disclosure.

In the accompanying drawings, the thicknesses, sizes and shapes of the lenses/lens piece are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens and/or lens element surface is a convex surface and the position of the convex surface is not defined, it represents that the lens and/or lens element surface is a convex surface at least at the paraxial area. If the lens and/or lens element surface is a concave surface and the position of the concave surface is not defined, it represents that the lens and/or lens element surface is a concave surface at least at the paraxial area. A surface of each lens and/or lens element that is closest to a first side (e.g., the side near the eye) is referred to as the first-side surface of the lens and/or lens piece, and a surface of the each lens and/or lens piece that is closest to a second side (e.g., the side away from the eye) is referred to as the second-side surface of the lens and/or lens piece.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, the use of “may,” when describing implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that implementations in the present disclosure and the features in the embodiments may be combined with each other on a non-conflict basis. Implementations of the present disclosure will be described below in detail with reference to the accompanying drawings.

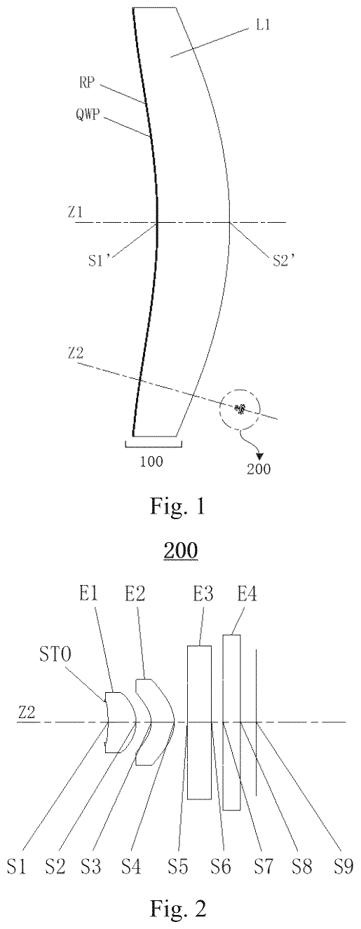

Referring to FIG. 1 and FIG. 2, a first aspect of the present disclosure provides a visual optical system, which may include a first optical system and a second optical system sequentially from a first side to a second side. The first optical system may be configured as a catadioptric optical system. The second optical system is configured to collect an eyeball image of a user, and to acquire gaze point information of the human eye based on the collected eyeball image, in order to achieve the function of eye-tracking. The number of the first optical systems may be one or more. The number of the second optical systems may be one or more. In an example, the visual optical system may include two first optical systems and two second optical systems symmetrically disposed.

In exemplary implementations, the first optical system may include a reflective polarizing element, a quarter wave plate, and a first lens piece sequentially arranged from the first side to the second side along a first optical axis (e.g., a Z1 axis). The polarization state of light changes after the light passes through the quarter-wave plate. The light with the changed polarization state is then reflected or transmitted at the reflective polarizing element, thereby causing the light to be refracted and reflected between the reflective polarizing element and the second-side surface of the first lens piece, effectively shortening a body length of the first optical system.

In exemplary implementations, the first lens piece may have a positive refractive power, the first-side surface of the first lens piece is a concave surface, and the second-side surface of the first lens piece is a convex surface.

In exemplary implementations, the reflective polarizing element is laminated with the quarter wave plate and is adhered to the first-side surface of the first lens. Here, compared to the reflective polarizing element, the quarter wave plate is closer to the first-side surface of the first lens. The reflective polarizing element and the quarter wave plate are laminated together to form one film layer, yield of adherence of the film layer may be improved.

In exemplary implementation, the first optical system may also include a partially reflective layer, which may be adhered to the second-side surface of the first lens. The partially reflective layer has a semi-transmissive and semi-reflective effect on the light. By providing the partially reflective layer, and combining the reflective polarizing element and the quarter wave plate, it allows for multiple refractions and reflections of the light, effectively reducing the body length of the first optical system.

In exemplary implementations, the second optical system may include a first lens and a second lens sequentially arranged from the first side to the second side along a second optical axis (e.g., a Z2 axis). There may be a spacing distance (e.g., air spacing) between the first lens and the second lens.

In exemplary implementations, the first lens may have a positive refractive power, the first-side surface of the first lens may be a convex surface or a concave surface, and the second-side surface of the first lens may be a convex surface or a concave surface.

In exemplary implementations, the second lens may have a positive refractive power or a negative refractive power, the first-side surface of the second lens may be a concave surface, and the second-side surface of the second lens may be a convex surface or a concave surface.

In exemplary implementations, the second optical system may also include a diaphragm, which may be disposed between the first optical system and the first lens.

In exemplary implementations, the first side may be the side closer to the human eye, while the second side may be the side farther from the human eye. Correspondingly, the first-side surface of each element (the reflective polarizing element, the quarter wave plate, the first lens piece, the first lens and the second lens) may be referred to as a near-eye side surface, and the second-side surface may be referred to as an away-from-eye side surface.

In exemplary implementations, a display screen may be provided on the second side of the visual optical system, and the second optical system is disposed between the first optical system and the display screen. Light from the human eye passes through the first optical system and then reaches the second optical system, and the second optical system receives the light and presents an image. By placing the second optical system on the away-from-eye side of the first optical system, it enables the visual optical system to have an eye-tracking function without affecting the performance and functionality of the first optical system, improves the appearance of a subsequent apparatus incorporating the visual optical system, and enables the second optical system to be invisible to the eye, thereby improving the aesthetic appeal of the apparatus.

In exemplary implementations, an angle θ between the second optical axis and the first optical axis may satisfy: 0°<θ<90°. By controlling the angle between the second optical axis and the first optical axis, it is possible to place the second optical system on the outer side of the first optical system, which allows the second optical system to photograph an eyeball image while ensuring the performance and functionality of the first optical system, thereby realizing the function of eye-tracking.

In exemplary implementations, a radius of curvature R1m of the first-side surface of the first lens piece, a radius of curvature R2m of the second-side surface of the first lens piece, a combined focal length f12e of the first lens and the second lens, and a distance TDe on the second optical axis from the first-side surface of the first lens to the second-side surface of the second lens may satisfy: 0.8<(R1m/R2m)/(f12e/TDe)<2.0. The second optical system includes two lenses and is a macro system, and the second optical system has a large range of depth of field. When the second optical system has a large depth of field, disposing the first optical system on the first side of the second optical system is conducive to reducing the loss of overall optical performance of the visual optical system. In addition, by constraining (R1m/R2m)/(f12e/TDe) within a reasonable range, it allows for a small radius of curvature of the first-side surface of the first lens piece, which is conducive to reducing the size of the image plane of the first optical system and achieving miniaturization of the display screen on the second side of the visual optical system; at the same time, it may enable the second optical system to have a small total length, reduce the volume of the second optical system, which is conducive to the combination and assembly of the second optical system with the first optical system.

In exemplary implementations, a center thickness CT2e of the second lens on the second optical axis and a radius of curvature R3e of the first-side surface of the second lens may satisfy: −1.25<CT2e/R3e<−0.15. Reasonably configuring the ratio of the center thickness of the second lens on the second optical axis to the radius of curvature of the first-side surface of the second lens can effectively control an effective focal length of the second lens, increase a height of light on the image plane, thereby reducing the length of the second optical system.

In exemplary implementations, an effective focal length f1e of the first lens and an effective focal length f2e of the second lens may satisfy: −1.1≤(f1e+f2e)/(f1e−f2e)≤2.0. By controlling the relationship between the effective focal length of the first lens and the effective focal length of the second lens, it can reasonably distribute the refractive powers of the two lenses in the second optical system, which is conducive to correcting aberrations of the visual optical system.

In exemplary implementations, a radius of curvature R1e of the first-side surface of the first lens and a radius of curvature R2e of the second-side surface of the first lens may satisfy: −1.95<(R1e−R2e)/(R1e+R2e)<1.05. By controlling the relationship between the radius of curvature of the first-side surface of the first lens and the radius of curvature of the second-side surface of the first lens, it is conducive to constraining the shape of the first lens, so as to control the refractive power of the first lens to be positive, to reduce an object distance of the second optical system, and to achieve a macro effect of the second optical system.

In exemplary implementations, the effective focal length f1e of the first lens and the radius of curvature R1e of the first-side surface of the first lens may satisfy: 0<f1e/|R1e|<1.8. Reasonably configuring the ratio of the effective focal length of the first lens to the radius of curvature of the first-side surface of the first lens may constrain the shape of the first lens, which is conducive to molding processing of the first lens.

In exemplary implementations, a total effective focal length f of the visual optical system, a refractive index N1e of the first lens and a refractive index N1m of the first lens piece may satisfy: 0.5 mm<f×(N1e/N1m)<0.75 mm. By controlling the relationship among the total effective focal length of the visual optical system, the refractive index of the first lens, and the refractive index of the first lens piece, it can achieve a small total effective focal length of the visual optical system, increase a field-of-view of the visual optical system, facilitating capturing more eye features during eye tracking using the visual optical system.

In exemplary implementations, a center thickness CT1m of the first lens piece on the first optical axis, a center thickness CTR of the reflective polarizing element on the first optical axis, a center thickness CTQ of the quarter wave plate on the first optical axis, and the total effective focal length f of the visual optical system may satisfy: 18.85<(CT1m+CTR+CTQ)/f<24.4. By controlling the relationship among the center thickness of the first lens piece on the first optical axis, the center thickness of the reflective polarizing element on the first optical axis, the center thickness of the quarter wave plate on the first optical axis, and the total effective focal length of the visual optical system, it can ensure that the first optical system has a reasonable total body length, increase an optical path of light when light is refracted and reflected in the first optical system, and also facilitate miniaturization of the first optical system.

In exemplary implementations, the total effective focal length f of the visual optical system and the effective focal length f1e of the first lens may satisfy: 0.15<f/f1e<1.35. Reasonably configuring the ratio of the total effective focal length of the visual optical system to the effective focal length of the first lens, the refractive power of the first lens can be kept low, which is conducive to reasonably distributing the refractive powers of the two lenses in the second optical system, thereby improving an imaging quality of the second optical system.

In exemplary implementations, the combined focal length f12e of the first lens and the second lens, a combined focal length fzm of the reflective polarizing element, the quarter wave plate and the first lens piece, and the radius of curvature R2m of the second-side surface of the first lens piece may satisfy: −4.25 mm<f12e×(fzm/R2m)<−3.25 mm. By controlling the above conditional expression, it enables the radius of curvature of the second-side surface of the first lens piece to be negative, and enables a total effective focal length of the first optical system to be greater than the radius of curvature of the second-side surface of the first lens piece, effectively constrains the shape of the second-side surface of the first lens piece, and controls a deflection angle of light on the first lens piece to be reasonable, thereby mitigating angular effects of the reflective polarizing element and the quarter wave plate.

In exemplary implementations, the combined focal length f12e of the first lens and the second lens, an effective focal length f1m of the first lens piece, and the center thickness CT1m of the first lens piece on the first optical axis may satisfy: 12.3 mm<f12e×(f1m/CT1m)<15.95 mm. By controlling the relationship among the combined focal length of the first lens and the second lens, the effective focal length of the first lens piece, and the center thickness of the first lens piece on the first optical axis, the effective focal length and the center thickness of the first lens piece may be effectively balanced, indirectly constraining the shape of the first lens piece, which is conducive to molding of the first lens piece.

In exemplary implementations, a center thickness CT1e of the first lens on the second optical axis, the center thickness CT2e of the second lens on the second optical axis, and the total effective focal length f of the visual optical system may satisfy: 0.45<(CT1e+CT2e)/f<1.35. By controlling the relationship among the center thickness of the first lens on the second optical axis, the center thickness of the second lens on the second optical axis, and the total effective focal length of the visual optical system, it is conducive to constraining the center thicknesses of the first lens and the second lens, so as to effectively constrain the length of the second optical system, and to achieve miniaturization of the visual optical system.

In exemplary implementations, the total effective focal length f of the visual optical system, an Abbe number V2e of the second lens, and an Abbe number V1e of the first lens may satisfy: 0.5 mm<f×(V2e/V1e)<0.7 mm. By controlling the above conditional expression, it enables the Abbe number of the first lens to be similar to the Abbe number of the second lens. For example, the first lens and the second lens both adopt low-refractive-index material, thus a production cost of the second optical system may be reduced.

In exemplary implementations, the distance TDe on the second optical axis from the first-side surface of the first lens to the second-side surface of the second lens, the center thickness CTR of the reflective polarizing element on the first optical axis, and the center thickness CTQ of the quarter wave plate on the first optical axis may satisfy: 1.8<TDe/(CTR+CTQ)<4.45. By controlling the above conditional expression, the length of the second optical system can be effectively constrained, the volume of the second optical system can be reduced, and the possibility of integrating the second optical system into the second side of the first optical system can be increased.

In exemplary implementations, the combined focal length f12e of the first lens and the second lens, and the center thickness CTQ of the quarter wave plate on the first optical axis, may satisfy: 5.65<f12e/CTQ<7.4. Reasonably configuring the ratio of the combined focal length of the first lens and the second lens to the center thickness of the quarter wave plate on the first optical axis enables the thickness of the quarter wave plate to be thin, effectively avoids the risk of uneven phase delay caused by stretching the quarter wave plate, and facilitates a curved-surface lamination process.

In a second aspect, implementations of the present disclosure provide a visual optical system, the visual optical system includes a first optical system and a second optical system sequentially from a first side to a second side. The first optical system includes, sequentially from the first side to the second side along a first optical axis, a reflective polarizing element, a quarter wave plate and a first lens piece; where, the first lens piece has a positive refractive power, the first-side surface of the first lens piece is a concave surface, and the second-side surface of the first lens piece is a convex surface. The second optical system includes, sequentially from the first side to the second side along a second optical axis, a first lens having a positive refractive power and a second lens having a refractive power; where, the first-side surface of the second lens is a concave surface. The number of lenses having refractive powers in the second optical system is two.

A combined focal length f12e of the first lens and the second lens, a combined focal length fzm of the reflective polarizing element, the quarter wave plate and the first lens piece, and a radius of curvature R2m of the second-side surface of the first lens piece may satisfy: −4.25 mm<f12e×(fzm/R2m)<−3.25 mm. The visual optical system provided in implementations of the present disclosure is configured in the form of a structure combining the first optical system and the second optical system, where the first optical system includes the first lens piece, the reflective polarizing element and the quarter wave plate, and the second optical system includes two lenses and is a macro system. The second optical system has a large range of depth of field, and by disposing the first optical system on the first side of the second optical system, it is conducive to reducing the loss of overall optical performance of the visual optical system. In addition, by constraining f12e×(fzm/R2m) within a reasonable range, it enables the radius of curvature of the second-side surface of the first lens piece to be negative, and enables the total effective focal length of the first optical system to be greater than the radius of curvature of the second-side surface of the first lens piece, effectively constrains the shape of the second-side surface of the first lens piece, and controls the deflection angle of light on the first lens piece to be reasonable, thereby mitigating the angular effects of the reflective polarizing element and the quarter wave plate.

It should be understood by those skilled in the art that the various results and advantages described in implementations of the present disclosure may be obtained by changing the number of the lenses and spacing elements constituting the visual optical system without departing from the technical solution claimed by the present disclosure.

Detailed embodiments of the visual optical system that may be applicable to the above implementations are further described below with reference to the accompanying drawings.

### Embodiment 1

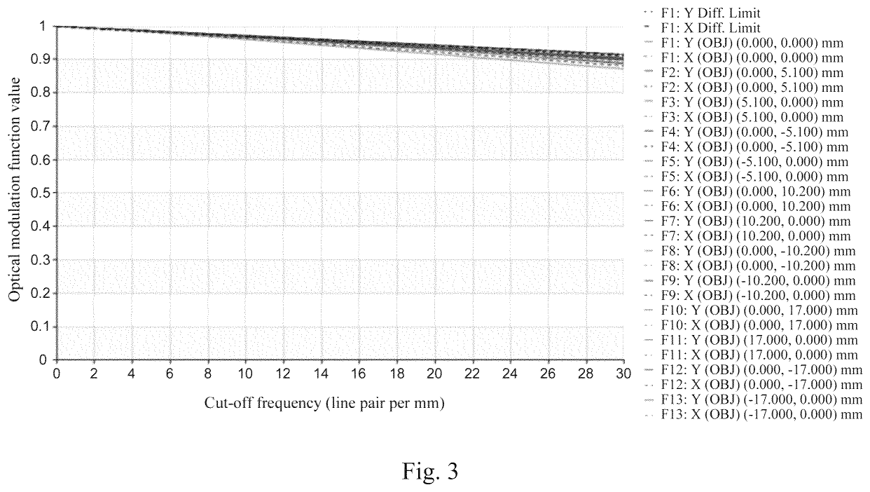

A visual optical system according to Embodiment 1 of the present disclosure is described below with reference to FIG. 1 to FIG. 3. FIG. 1 illustrates a schematic structural diagram of the visual optical system according to Embodiment 1. FIG. 2 illustrates a schematic structural diagram of a second optical system according to Embodiment 1. FIG. 3 illustrates a modulation transfer function curve of the visual optical system according to Embodiment 1.

As shown in FIG. 1 and FIG. 2, the visual optical system may include a first optical system 100 and a second optical system 200 sequentially from a first side to a second side, and the second optical system 200 is disposed on an away-from-eye side of the first optical system. The first optical system 100 includes a reflective polarizing element RP, a quarter wave plate QWP, and a first lens piece L1 sequentially from a near-eye side to an away-from-eye side along a first optical axis. The second optical system 200 includes a first lens E1 and a second lens E2 sequentially from a near-eye side to an away-from-eye side along a second optical axis. A diaphragm STO may be provided between the first optical system 100 and the first lens E1.

Here, the first lens piece L1 has a positive refractive power, a near-eye side surface S1′ of the first lens piece L1 is a concave surface, and an away-from-eye side surface S2′ of the first lens piece L1 is a convex surface. The quarter wave plate QWP has a near-eye side surface and an away-from-eye side surface, and the away-from-eye side surface of the quarter wave plate QWP is adhered to the near-eye side surface S1′ of the first lens piece L1. The reflective polarizing element RP has a near-eye side surface and an away-from-eye side surface, and the away-from-eye side surface of the reflective polarizing element RP is adhered to the near-eye side surface of the quarter wave plate QWP.

Here, the first lens E1 has a positive refractive power, the near-eye side surface S1 of the first lens E1 is a concave surface, and the away-from-eye side surface S2 of the first lens E1 is a convex surface. The second lens E2 has a positive refractive power, the near-eye side surface S3 of the second lens E2 is a concave surface, and the away-from-eye side surface S4 of the second lens E2 is a convex surface. An optical filter E3 and a protective glass E4 may also be provided between the image plane S9 and the away-from-eye side surface S4 of the second lens E2. Light from an object sequentially passes through the surfaces S1′, S2′ and S1 to S8 and finally forms an image on the image plane S9.

Table 1 shows a table of basic parameters of the visual optical system in Embodiment 1. Here, the units of a radius of curvature, a thickness/distance are all millimeters (mm).

TABLE 1

| | | | | material | | conic |
|---|---|---|---|---|---|---|
| surface | surface | radius of | | refractive | abbe | coef- |
| number | type | curvature | thickness | index | number | ficient |
| near- | | infinite | 30.0000 | | | |
| eye side | | | | | | |
| RP | aspheric | −64.6288 | 0.1000 | 1.491 | 57.00 | −1.0116 |
| QWP | aspheric | −64.6288 | 0.1000 | 1.491 | 57.00 | −1.0116 |
| S1′ | aspheric | −64.6288 | 12.8300 | 1.535 | 55.92 | −1.0116 |
| S2′ | aspheric | −48.1659 | 1.5335 | | | −5.7686 |
| STO | | infinite | 0.0300 | | | |
| S1 | aspheric | −1.5116 | 0.2484 | 1.562 | 26.38 | 73.8229 |
| S2 | aspheric | −0.2410 | 0.1360 | | | −0.3218 |
| S3 | aspheric | −0.1690 | 0.2100 | 1.562 | 26.38 | −0.9946 |
| S4 | aspheric | −0.2396 | 0.1000 | | | −0.9472 |
| S5 | | infinite | 0.2100 | 1.508 | 64.17 | |
| S6 | | infinite | 0.1000 | | | |
| S7 | | infinite | 0.1500 | 1.508 | 64.17 | |
| S8 | | infinite | 0.1335 | | | |
| S9 | | infinite | 0.0000 | | | |

In the present embodiment, both the near-eye side surfaces and the away-from-eye side surfaces of the first lens piece L1, the first lens E1 and the second lens E2 are aspheric surfaces, and the surface type x of each aspheric lens may be defined using, but not limited to, the following aspheric formula:

$$x = \frac{{ch}^{2}}{1 + \sqrt{1 - ( k + 1 ) {c}^{2} {h}^{2}}} + \sum {Aih}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 2 below shows the high-order coefficients A₄, A₆, A₈, A₁₀, A₁₂, A₁₄, A₁₆, A₁₈ and A₂₀ applicable to the aspheric surfaces S1′, S2′, S1, S2, S3, S4 in Embodiment 1.

TABLE 2

| surface number | A4 | A6 | A8 | A10 |
|---|---|---|---|---|
| S1′ | 5.6060E−06 | −2.0180E−09 | 9.8075E−13 | 0.0000E+00 |
| S2′ | −4.9740E−06 | 5.1765E−09 | −2.9203E−12 | 1.4943E−15 |
| S1 | −7.8580E+00 | 1.6121E+02 | −1.3879E+04 | 2.2959E+05 |
| S2 | 6.2031E+00 | −1.2107E+02 | 3.4479E+03 | −4.2601E+04 |
| S3 | 9.3031E+00 | 1.6968E+02 | −3.3526E+03 | 1.8888E+04 |
| S4 | 3.8727E+00 | −6.4950E01 | 2.1314E+02 | −1.8730E+03 |

| surface | | | | | |
|---|---|---|---|---|---|
| number | A12 | A14 | A16 | A18 | A20 |
| S1′ | 0.0000E+00 | 0.0000E+00 | 0.0000E+00 | 0.0000E+00 | 0.0000E+00 |
| S2′ | 0.0000E+00 | 0.0000E+00 | 0.0000E+00 | 0.0000E+00 | 0.0000E+00 |
| S1 | 3.6784E−05 | −6.6633E−07 | −1.1798E−04 | −5.2216E−04 | −1.9742E−03 |
| S2 | 1.0124E+04 | 3.8942E+04 | −7.8664E−04 | −3.0515E−03 | −6.6349E−03 |
| S3 | −1.3875E+03 | 6.5600E+04 | 2.1805E+05 | −7.7689E+05 | −1.2665E+06 |
| S4 | −1.0831E+−03 | 9.5778E+03 | 2.0199E+05 | 7.1793E+05 | −7.7408E+06 |

### Embodiment 2

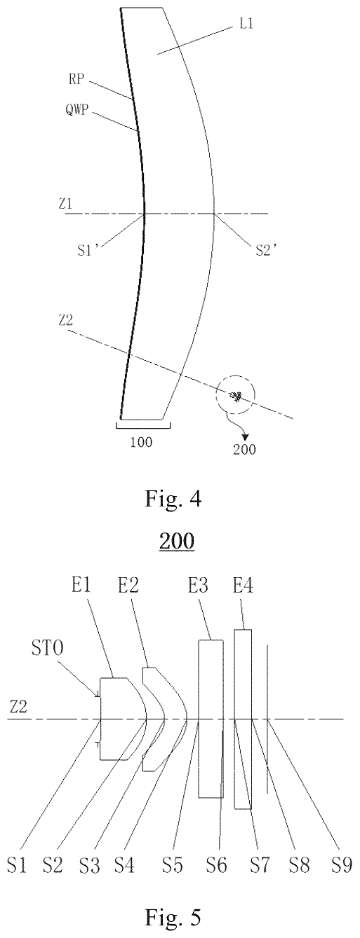

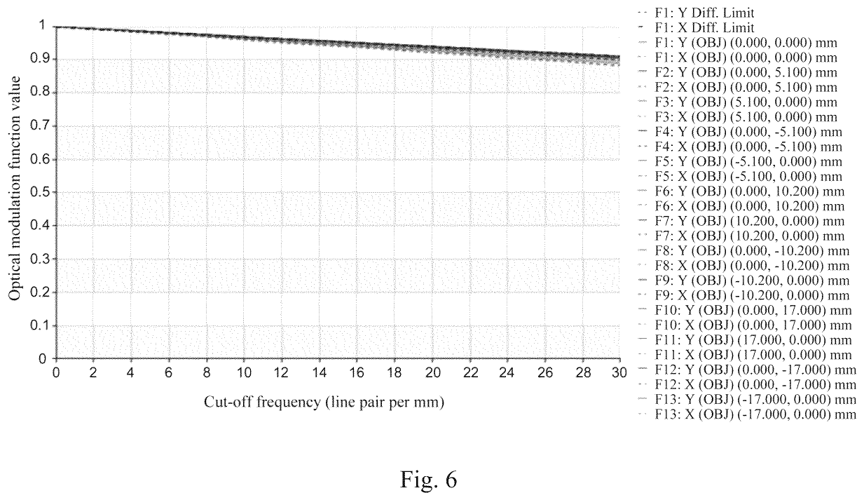

A visual optical system according to Embodiment 2 of the present disclosure is described below with reference to FIG. 4 to FIG. 6. FIG. 4 illustrates a schematic structural diagram of the visual optical system according to Embodiment 2. FIG. 5 illustrates a schematic structural diagram of a second optical system according to Embodiment 2. FIG. 6 illustrates a modulation transfer function curve of the visual optical system according to Embodiment 2.

As shown in FIG. 4 and FIG. 5, the visual optical system may include a first optical system 100 and a second optical system 200 sequentially from a first side to a second side, and the second optical system 200 is disposed on an away-from-eye side of the first optical system. The first optical system 100 includes a reflective polarizing element RP, a quarter wave plate QWP, and a first lens piece L1 sequentially from a near-eye side to an away-from-eye along a first optical axis. The second optical system 200 includes a first lens E1 and a second lens E2 sequentially from a near-eye side to an away-from-eye side along a second optical axis. A diaphragm STO may be provided between the first optical system 100 and the first lens E1.

Here, the first lens piece L1 has a positive refractive power, a near-eye side surface S1′ of the first lens piece L1 is a concave surface, and an away-from-eye side surface S2′ of the first lens piece L1 is a convex surface. The quarter wave plate QWP has a near-eye side surface and an away-from-eye side surface, and the an away-from-eye side of the quarter wave plate QWP is adhered to the near-eye side surface S1′ of the first lens piece L1. The reflective polarizing element RP has a near-eye side surface and an away-from-eye side surface, and the away-from-eye side surface of the reflective polarizing element RP is adhered to the near-eye side of the quarter wave plate QWP.

Here, the first lens E1 has a positive refractive power, a near-eye side surface S1 of the first lens E1 is a convex surface, and an away-from-eye side surface S2 of the first lens E1 is a convex surface. The second lens E2 has a positive refractive power, a near-eye side surface S3 of the second lens E2 is a concave surface, and an away-from-eye side surface S4 of the second lens E2 is a convex surface. An optical filter E3 and a protective glass E4 may also be provided between the image plane S9 and the away-from-eye side surface S4 of the second lens E2. Light from an object sequentially passes through the surfaces S1′, S2′ and S1 to S8 and finally forms an image on the image plane S9.

Table 3 shows a table of basic parameters of the visual optical system in Embodiment 2. Here, the units of a radius of curvature, a thickness/distance are all millimeters (mm).

TABLE 3

| | | | | material | | |
|---|---|---|---|---|---|---|
| | | | | re- | | |
| surface | surface | radius of | thick- | fractive | abbe | conic |
| number | type | curvature | ness | index | number | coefficient |
| near- | | infinite | 30.0000 | | | |
| eye side | | | | | | |
| RP | aspheric | −64.6288 | 0.1000 | 1.491 | 57.00 | −1.0116 |
| QWP | aspheric | −64.6288 | 0.1000 | 1.491 | 57.00 | −1.0116 |
| S1′ | aspheric | −64.6288 | 12.8300 | 1.535 | 55.92 | −1.0116 |
| S2′ | aspheric | −48.1659 | 1.5335 | | | −5.7686 |
| STO | | Infinite | 0.0300 | | | |
| S1 | aspheric | 98.4800 | 0.4004 | 1.562 | 26.38 | 3.0143E+05 |
| S2 | aspheric | −0.2998 | 0.1581 | | | −0.5646 |
| S3 | aspheric | −0.1667 | 0.2000 | 1.562 | 26.38 | −0.9074 |
| S4 | aspheric | −0.2322 | 0.1000 | | | −0.8553 |
| S5 | | infinite | 0.2100 | 1.508 | 64.17 | |
| S6 | | infinite | 0.1000 | | | |
| S7 | | infinite | 0.1500 | 1.508 | 64.17 | |
| S8 | | infinite | 0.1335 | | | |
| S9 | | infinite | 0.0000 | | | |

In the present embodiment, both the near-eye side surfaces and the away-from-eye side surfaces of the first lens piece L1, the first lens E1 and the second lens E2 are aspheric surfaces. Table 4 shows the high-order coefficients A4, A6, A8, A10, A12, A14, A16, A18 and A20 applicable to the aspheric surfaces S1′, S2′, S1, S2, S3, S4 in Embodiment 2.

TABLE 4

| surface number | A4 | A6 | A8 | A10 |
|---|---|---|---|---|
| S1′ | 5.6060E−06 | −2.0180E−09 | 9.8075E−13 | 0.0000E+00 |
| S2′ | −4.9740E−06 | 5.1765E−09 | −2.9203E−12 | 1.4943E−15 |
| S1 | −4.2261E+00 | −4.4694E+00 | −1.2195E+03 | 1.0956E+04 |
| S2 | 2.4224E+00 | −1.4599E+01 | [symbol] 2.1445E+02 | −1.9828E+03 |
| S3 | 7.7568E+00 | 5.2458E+01 | −5.5925E+01 | −5.5733E+02 |
| S4 | [symbol] .0262E+00 | −1.6421E+00 | [symbol] .0853E+02 | −1.7374E+03 |

| surface | | | | | |
|---|---|---|---|---|---|
| number | A12 | A14 | A16 | A18 | A20 |
| S1′ | [symbol] .0000E+ [symbol] 0 | [symbol] .0000E+ [symbol] 0 | [symbol] .0000E+ [symbol] 0 | [symbol] .0000E+ [symbol] 0 | [symbol] .0000E+ [symbol] 0 |
| S2′ | [symbol] .0000E+ [symbol] 0 | [symbol] .0000E+ [symbol] 0 | [symbol] .0000E+ [symbol] 0 | [symbol] .0000E+ [symbol] 0 | [symbol] .0000E+ [symbol] 0 |
| S1 | 3.6784E−05 | −6.6633E−07 | −1.1798E−04 | −5.2216E−04 | −1.9742E−03 |
| S2 | 1.0124E+04 | [symbol] .8942E+04 | −7.8664E−04 | −3.0515E−03 | −6.6349E−03 |
| S3 | −1.3875E+03 | 6.5600E+04 | 2.1805E+05 | −7.7689E+05 | − [symbol] .2665E+06 |
| S4 | −1.0831E+03 | 9.5778E+03 | 2.0199E+05 | 7.1793E+05 | −7.7408E+06 |

[symbol]

indicates data missing or illegible when filed

### Embodiment 3

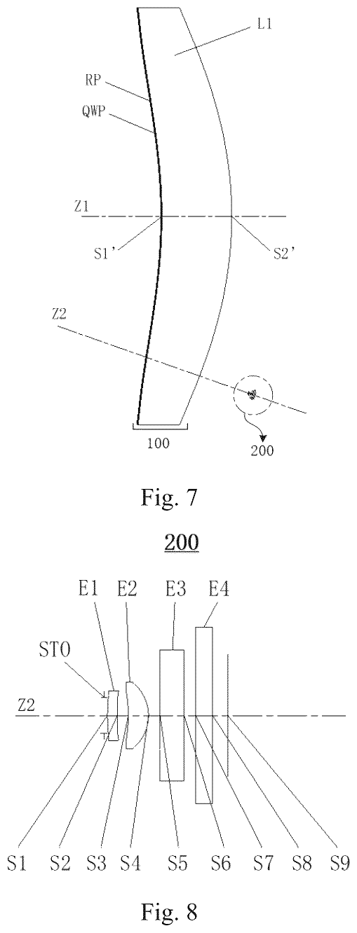

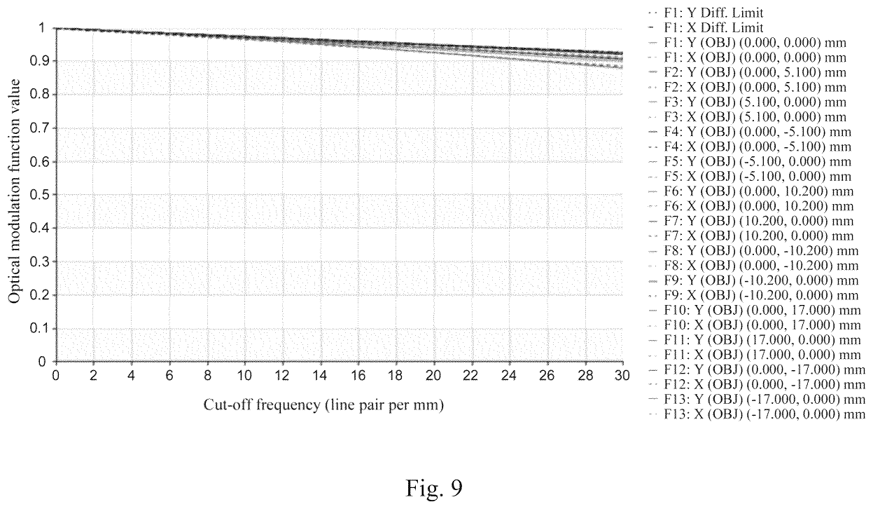

A visual optical system according to Embodiment 3 of the present disclosure is described below with reference to FIG. 7 to FIG. 9. FIG. 7 illustrates a schematic structural diagram of the visual optical system according to Embodiment 3. FIG. 8 illustrates a schematic structural diagram of a second optical system according to Embodiment 3. FIG. 9 illustrates a modulation transfer function curve of the visual optical system according to Embodiment 3.

As shown in FIG. 7 and FIG. 8, the visual optical system may include a first optical system 100 and a second optical system 200 sequentially from a first side to a second side, and the second optical system 200 is disposed on an away-from-eye side of the first optical system. The first optical system 100 includes a reflective polarizing element RP, a quarter wave plate QWP, and a first lens piece L1 sequentially from a near-eye side to an away-from-eye along a first optical axis. The second optical system 200 includes a first lens E1 and a second lens E2 sequentially from a near-eye side to an away-from-eye along a second optical axis. A diaphragm STO may be provided between the first optical system 100 and the first lens E1.

Here, the first lens piece L1 has a positive refractive power, a near-eye side surface S1′ of the first lens piece L1 is a concave surface, and an away-from-eye surface S2′ of the first lens piece L1 is a convex surface. The quarter wave plate QWP has a near-eye side surface and an away-from-eye surface, and the away-from-eye side surface of the quarter wave plate QWP is adhered to the near-eye side surface S1′ of the first lens piece L1. The reflective polarizing element RP has a near-eye side surface and an away-from-eye surface, and the away-from-eye surface of the reflective polarizing element RP is adhered to the near-eye side surface of the quarter wave plate QWP.

Here, the first lens E1 has a positive refractive power, a near-eye side surface S1 of the first lens E1 is a convex surface, and an away-from-eye surface S2 of the first lens E1 is a convex surface. The second lens E2 has a positive refractive power, a near-eye side surface S3 of the second lens E2 is a concave surface, and an away-from-eye surface S4 of the second lens E2 is a convex surface. An optical filter E3 and a protective glass E4 may also be provided between the image plane S9 and the away-from-eye side surface S4 of the second lens E2. Light from an object sequentially passes through the surfaces S1′, S2′ and S1 to S8 and finally forms an image on the image plane S9.

Table 5 shows a table of basic parameters of the visual optical system in Embodiment 3. Here, the units of a radius of curvature, a thickness/distance are all millimeters (mm).

TABLE 5

| | | | | material | | conic |
|---|---|---|---|---|---|---|
| surface | surface | radius of | thick- | refractive | abbe | coef- |
| number | type | curvature | ness | index | number | ficient |
| near- | | infinite | 30.0000 | | | |
| eye side | | | | | | |
| RP | aspheric | −64.6288 | 0.1000 | 1.491 | 57.00 | −1.0116 |
| QWP | aspheric | −64.6288 | 0.1000 | 1.491 | 57.00 | −1.0116 |
| S1′ | aspheric | −64.6288 | 12.8300 | 1.535 | 55.92 | −1.0116 |
| S2′ | aspheric | −48.1659 | 1.5335 | | | −5.7686 |
| STO | | Infinite | 0.0300 | | | |
| S1 | aspheric | 1.5636 | 0.0865 | 1.562 | 26.38 | 65.5105 |
| S2 | aspheric | −5.0000 | 0.1000 | | | −326.6616 |
| S3 | aspheric | −0.8420 | 0.1800 | 1.562 | 26.38 | 7.6249 |
| S4 | aspheric | −0.2921 | 0.1000 | | | −0.5710 |
| S5 | | infinite | 0.2100 | 1.508 | 64.17 | |
| S6 | | infinite | 0.1000 | | | |
| S7 | | infinite | 0.1500 | 1.508 | 64.17 | |
| S8 | | infinite | 0.1335 | | | |
| S9 | | infinite | 0.0000 | | | |

In the present embodiment, both the near-eye side surfaces and the far-eye side surfaces of the first lens piece L1, the first lens E1 and the second lens E2 are aspheric surfaces. Table 6 shows the high-order coefficients A₄, A₆, A₈, A₁₀, A₁₂, A₁₄, A₁₆, A₁₈ and A₂₀ applicable to the aspheric surfaces S1′, S2′, S1, S2, S3, S4 in Embodiment 3.

TABLE 6

| surface number | A4 | A6 | A8 | A10 |
|---|---|---|---|---|
| S1′ | 5.6060E−06 | −2.0180E−09 | 9.8075E−13 | 0.0000E+00 |
| S2′ | −4.9740E−06 | 5.1765E−09 | −2.9203E−12 | 1.4943E−15 |
| S1 | −8.1381E−02 | 2.3000E +02 | −1.2948E+04 | 7.9706E+04 |
| S2 | 1.2820E+01 | 3.8278E+01 | 2.5733E+03 | −1.0847E+05 |
| S3 | 2.7716E+00 | 1.2480E+02 | −2.8062E+03 | 2.5109E+04 |
| S4 | −3.2609E−01 | −1.3108E+01 | 5.6747E+01 | −5.7832E+03 |

| surface | | | | | |
|---|---|---|---|---|---|
| number | A12 | A14 | A16 | A18 | A20 |
| S1′ | 0.0000E+00 | 0.0000E+00 | 0.0000E+00 | 0.0000E+00 | 0.0000E+00 |
| S2′ | 0.0000E+00 | 0.0000E+00 | 0.0000E+00 | 0.0000E+00 | 0.0000E+00 |
| S1 | 3.6784E−05 | −6.6633E−07 | −1.1798E−04 | −5.2216E−04 | −1.9742E−03 |
| S2 | 1.0124E+04 | 3.8942E+04 | −7.8664E−04 | −3.0515E−03 | −6.6349E−03 |
| S3 | −1.3875E+03 | 6.5600E+04 | 2.1805E+05 | −7.7689E+05 | −1.2665E+06 |
| S4 | −1.0831E+03 | 9.5778E+03 | 2.0199E+05 | 7.1793E+05 | −7.7408E+06 |

### Embodiment 4

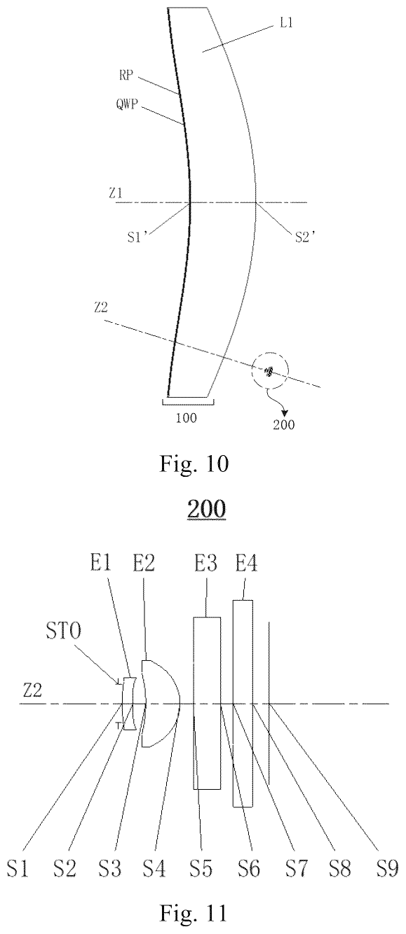

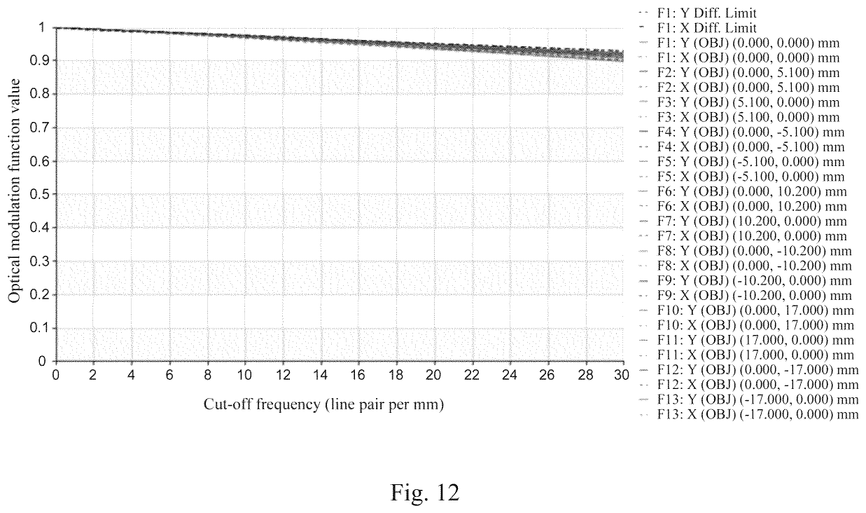

A visual optical system according to Embodiment 4 of the present disclosure is described below with reference to FIG. 10 to FIG. 12. FIG. 10 illustrates a schematic structural diagram of the visual optical system according to Embodiment 4. FIG. 11 illustrates a schematic structural diagram of a second optical system according to Embodiment 4. FIG. 12 illustrates a modulation transfer function curve of the visual optical system according to Embodiment 4.

As shown in FIG. 10 and FIG. 11, the visual optical system may include a first optical system 100 and a second optical system 200 sequentially from a first side to a second side, and the second optical system 200 is disposed on the away-from-eye of the first optical system. The first optical system 100 includes a reflective polarizing element RP, a quarter wave plate QWP, and a first lens piece L1 sequentially from a near-eye side to a far-eye side along a first optical axis. The second optical system 200 includes a first lens E1 and a second lens E2 sequentially from a near-eye side to an away-from-eye along a second optical axis. A diaphragm STO may be provided between the first optical system 100 and the first lens E1.

Here, the first lens piece L1 has a positive refractive power, a near-eye side surface S1′ of the first lens piece L1 is a concave surface, and an away-from-eye surface S2′ of the first lens piece L1 is a convex surface. The quarter wave plate QWP has a near-eye side surface and an away-from-eye surface, and the away-from-eye surface of the quarter wave plate QWP is adhered to the near-eye side surface S1′ of the first lens piece L1. The reflective polarizing element RP has a near-eye side surface and an away-from-eye surface, and the away-from-eye side surface of the reflective polarizing element RP is adhered to the near-eye side surface of the quarter wave plate QWP.

Here, the first lens E1 has a positive refractive power, a near-eye side surface S1 of the first lens E1 is a convex surface, and an away-from-eye side surface S2 of the first lens E1 is a concave surface. The second lens E2 has a positive refractive power, a near-eye side surface S3 of the second lens E2 is a concave surface, and an away-from-eye surface S4 of the second lens E2 is a convex surface. An optical filter E3 and a protective glass E4 may also be provided between the image plane S9 and the away-from-eye surface S4 of the second lens E2. Light from an object sequentially passes through the surfaces S1′, S2′ and S1 to S8 and finally forms an image on the image plane S9.

Table 7 shows a table of basic parameters of the visual optical system in Embodiment 4. Here, the units of a radius of curvature, a thickness/distance are all millimeters (mm).

TABLE 7

| | | | | material | | |
|---|---|---|---|---|---|---|
| surface | surface | radius of | | refractive | abbe | conic |
| number | type | curvature | thickness | index | number | coefficient |
| near- | | infinite | 30.0000 | | | |
| eye side | | | | | | |
| RP | aspheric | −64.6288 | 0.1000 | 1.491 | 57.00 | −1.0116 |
| QWP | aspheric | −64.6288 | 0.1000 | 1.491 | 57.00 | −1.0116 |
| S1′ | aspheric | −64.6288 | 12.8300 | 1.535 | 55.92 | −1.0116 |
| S2′ | aspheric | −48.1659 | 1.5335 | | | −5.7686 |
| STO | | Infinite | 0.0300 | | | |
| S1 | aspheric | 1.6717 | 0.0850 | 1.562 | 26.38 | 66.1509 |
| S2 | aspheric | 250.0000 | 0.1025 | | | −2.3010E+06 |
| S3 | aspheric | −0.8687 | 0.2745 | 1.562 | 26.38 | 12.2764 |
| S4 | aspheric | −0.2753 | 0.1000 | | | −0.4962 |
| S5 | | infinite | 0.2100 | 1.508 | 64.17 | |
| S6 | | infinite | 0.1000 | | | |
| S7 | | infinite | 0.1500 | 1.508 | 64.17 | |
| S8 | | infinite | 0.1335 | | | |
| S9 | | infinite | 0.0000 | | | |

In the present embodiment, both the near-eye side surfaces and the away-from-eye side surfaces of the first lens piece L1, the first lens E1 and the second lens E2 are aspheric surfaces. Table 8 shows the high-order coefficients A₄, A₆, A₈, A₁₀, A₁₂, A₁₄, A₁₆, Ais and Ax applicable to the aspheric surfaces S1′, S2′, S1, S2, S3, S4 in Embodiment 4.

TABLE 8

| surface number | A4 | A6 | A8 | A10 |
|---|---|---|---|---|
| S1′ | 5.6060E−06 | −2.0180E−09 | 9.8075E−13 | 0.0000E+00 |
| S2′ | −4.9740E−06 | 5.1765E−09 | −2.9203E−12 | 1.4943E−15 |
| S1 | 2.8185E+00 | 3.7013E+02 | −5.6960E+03 | −1.2868E+05 |
| S2 | 1.2511E+01 | 3.3384E+02 | 8.7627E+03 | −2.0431E+05 |
| S3 | −2.5049E+00 | 1.0372E+02 | −1.7054E+03 | 5.7616E+04 |
| S4 | −3.8379E−01 | −2.8105E+01 | 3.8987E+02 | −7.2573E+03 |

| surface | | | | | |
|---|---|---|---|---|---|
| number | A12 | A14 | A16 | A18 | A20 |
| S1′ | 0.0000E+00 | 0.0000E+00 | 0.0000E+00 | 0.0000E+00 | 0.0000E+00 |
| S2′ | 0.0000E+00 | 0.0000E+00 | 0.0000E+00 | 0.0000E+00 | 0.0000E+00 |
| S1 | 3.6784E−05 | −6.6633E−07 | −1.1798E−04 | −5.2216E−04 | −1.9742E−03 |
| S2 | 1.0124E+04 | 3.8942E+04 | −7.8664E−04 | −3.0515E−03 | −6.6349E−03 |
| S3 | −1.3875E+03 | 6.5600E+04 | 2.1805E+05 | −7.7689E+05 | −1.2665E+06 |
| S4 | −1.0831E+03 | 9.5778E+03 | 2.0199E+05 | 7.1793E+05 | −7.7408E+06 |

### Embodiment 5

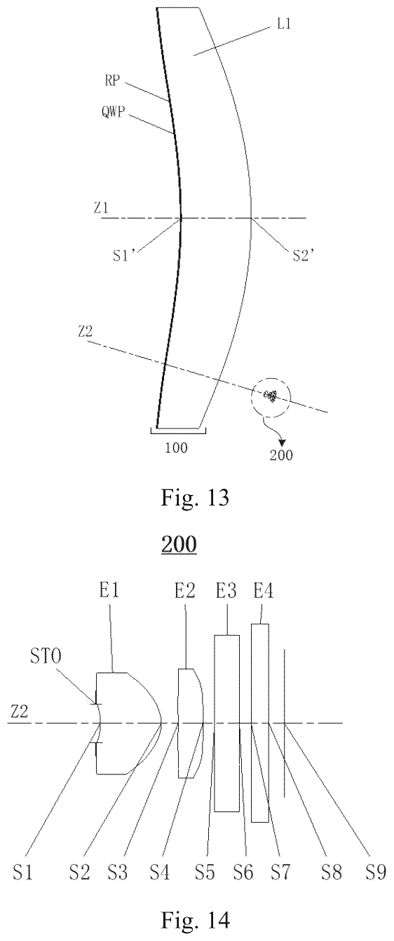

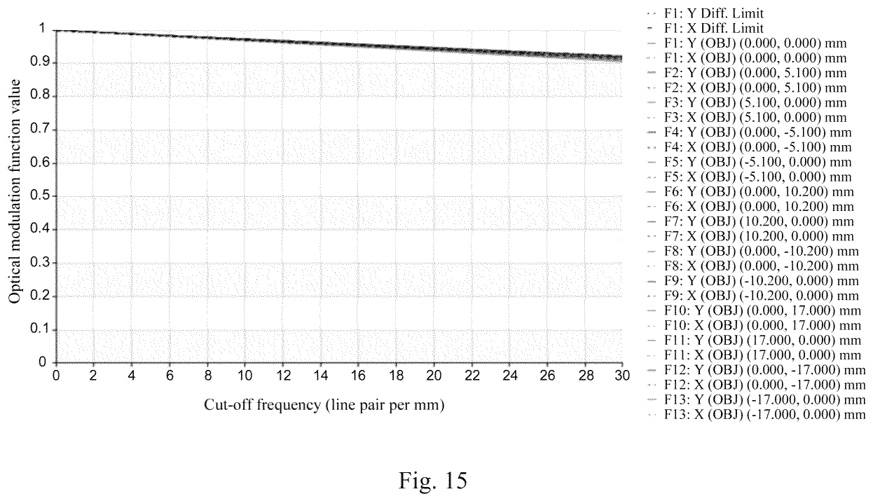

A visual optical system according to Embodiment 5 of the present disclosure is described below with reference to FIG. 13 to FIG. 15. FIG. 13 illustrates a schematic structural diagram of the visual optical system according to Embodiment 5. FIG. 14 illustrates a schematic structural diagram of a second optical system according to Embodiment 5. FIG. 15 illustrates a modulation transfer function curve of the visual optical system according to Embodiment 5.

As shown in FIG. 13 and FIG. 14, the visual optical system may include a first optical system 100 and a second optical system 200 sequentially from a first side to a second side, and the second optical system 200 is disposed on an away-from-eye side of the first optical system. The first optical system 100 includes a reflective polarizing element RP, a quarter wave plate QWP, and a first lens piece L1 sequentially from a near-eye side to an away-from-eye along a first optical axis. The second optical system 200 includes a first lens E1 and a second lens E2 sequentially from a near-eye side to an away-from-eye side along a second optical axis. A diaphragm STO may be provided between the first optical system 100 and the first lens E1.

Here, the first lens piece L1 has a positive refractive power, a near-eye side surface S1′ of the first lens piece L1 is a concave surface, and an away-from-eye surface S2′ of the first lens piece L1 is a convex surface. The quarter wave plate QWP has a near-eye side surface and an away-from-eye surface, and the away-from-eye surface of the quarter wave plate QWP is adhered to the near-eye side surface S1′ of the first lens piece L1. The reflective polarizing element RP has a near-eye side surface and an away-from-eye side surface, and the away-from-eye side surface of the reflective polarizing element RP is adhered to the near-eye side surface of the quarter wave plate QWP.

Here, the first lens E1 has a positive refractive power, a near-eye side surface S1 of the first lens E1 is a concave surface, and a far-eye side surface S2 of the first lens E1 is a convex surface. The second lens E2 has a negative refractive power, a near-eye side surface S3 of the second lens E2 is a concave surface, and an away-from-eye side surface of the second lens E2 is a concave surface. An optical filter E3 and a protective glass E4 may also be provided between an image plane S9 and the away-from-eye side surface S4 of the second lens E2. Light from an object sequentially passes through the surfaces S1′, S2′ and S1 to S8 and finally forms an image on the image plane S9.

Table 9 shows a table of basic parameters of the visual optical system in Embodiment 5. Here, the units of a radius of curvature, a thickness/distance are all millimeters (mm).

TABLE 9

| | | | | material | | conic |
|---|---|---|---|---|---|---|
| surface | surface | radius of | thick- | refractive | abbe | coef- |
| number | type | curvature | ness | index | number | ficient |
| near- | | infinite | 30.0000 | | | |
| eye side | | | | | | |
| RP | aspheric | −64.6288 | 0.1000 | 1.491 | 57.00 | −1.0116 |
| QWP | aspheric | −64.6288 | 0.1000 | 1.491 | 57.00 | −1.0116 |
| S1′ | aspheric | −64.6288 | 12.8300 | 1.535 | 55.92 | −1.0116 |
| S2′ | aspheric | −48.1659 | 1.5335 | | | −5.7686 |
| STO | | Infinite | 0.0300 | | | |
| S1 | aspheric | −0.4134 | 0.5364 | 1.562 | 26.38 | 2.8612 |
| S2 | aspheric | −0.2301 | 0.1366 | | | −0.7009 |
| S3 | aspheric | −1.1545 | 0.2079 | 1.562 | 26.38 | −99.0000 |
| S4 | aspheric | 480.0000 | 0.1000 | | | 99.0000 |
| S5 | | Infinite | 0.2100 | 1.508 | 64.17 | |
| S6 | | Infinite | 0.1000 | | | |
| S7 | | Infinite | 0.1500 | 1.508 | 64.17 | |
| S8 | | infinite | 0.1335 | | | |
| S9 | | infinite | 0.0000 | | | |

In the present embodiment, both the near-eye side surfaces and the far-eye side surfaces of the first lens piece L1, the first lens E1 and the second lens E2 are aspheric surfaces. Table 10 shows the high-order coefficients A₄, A₆, A₈, A₁₀, A₁₂, A₁₄, A₁₆, A₁₈ and A₂₀ applicable to the aspheric surfaces S1′, S2′, S1, S2, S3, S4 in Embodiment 5.

TABLE 10

| surface number | A4 | A6 | A8 | A10 |
|---|---|---|---|---|
| S1′ | 5.6060E−06 | −2.0180E−09 | 9.8075E−13 | 0.0000E+00 |
| S2′ | −4.9740E−06 | 5.1765E−09 | −2.9203E−12 | 1.4943E−15 |
| S1 | 6.8151E−02 | 1.0692E+02 | −3.3942E+03 | 1.1144E+05 |
| S2 | 1.2273E+01 | −1.2001E+02 | 1.1098E+03 | −5.6976E+03 |
| S3 | 1.0775E+01 | −1.6123E+02 | 1.3572E+03 | −6.2006E+03 |
| S4 | −9.8310E−01 | −4.3723E+01 | 4.5106E+02 | −2.2274E+03 |

| surface | | | | | |
|---|---|---|---|---|---|
| number | A12 | A14 | A16 | A18 | A20 |
| S1′ | 0.0000E+00 | 0.0000E+00 | 0.0000E+00 | 0.0000E+00 | 0.0000E+00 |
| S2′ | 0.0000E+00 | 0.0000E+00 | 0.0000E+00 | 0.0000E+00 | 0.0000E+00 |
| S1 | 3.6784E−05 | −6.6633E−07 | −1.1798E−04 | −5.2216E−04 | −1.9742E−03 |
| S2 | 1.0124E+04 | 3.8942E+04 | −7.8664E−04 | −3.0515E−03 | −6.6349E−03 |
| S3 | −1.3875E+03 | 6.5600E+04 | 2.1805E+05 | −7.7689E+05 | −1.2665E+06 |
| S4 | −1.0831E+03 | 9.5778E+03 | 2.0199E+05 | 7.1793E+05 | −7.7408E+06 |

Table 11 illustrates values of the parameters f, f1m, fzm, f1e, f2e and f12e for each of the embodiments in Embodiments 1-5.

TABLE 11

| embodiment parameter | 1 | 2 | 3 | 4 | 5 |
|---|---|---|---|---|---|
| f(mm) | 0.63 | 0.69 | 0.56 | 0.54 | 0.57 |
| f1m(mm) | 277.87 | 277.87 | 277.87 | 277.87 | 277.87 |
| fzm(mm) | 277.05 | 277.05 | 277.05 | 277.05 | 277.05 |
| f1e(mm) | 0.48 | 0.53 | 2.13 | 3.00 | 0.45 |
| f2e(mm) | 14.81 | 10.76 | 0.71 | 0.62 | −2.05 |
| f12e(mm) | 0.67 | 0.74 | 0.60 | 0.57 | 0.60 |

Table 12 illustrates values of the conditional expressions for each of the embodiments in Embodiments 1-5.

TABLE 12

| | embodiment | | | | |
|---|---|---|---|---|---|
| conditional expression | 1 | 2 | 3 | 4 | 5 |
| (R1m/R2m)/(f12e/TDe) | 1.19 | 1.38 | 0.82 | 1.09 | 1.95 |
| f × (N1e/N1m) (mm) | 0.64 | 0.70 | 0.57 | 0.54 | 0.58 |
| CT2e/R3e | −1.24 | −1.20 | −0.21 | −0.32 | −0.18 |
| (CT1m + CTR + CTQ)/f | 20.66 | 18.89 | 23.26 | 24.35 | 22.96 |
| (f1e + f2e)/(f1e − f2e) | −1.07 | −1.10 | 2.00 | 1.52 | −0.64 |
| f/f1e | 1.32 | 1.29 | 0.26 | 0.18 | 1.27 |
| f12e × (fzm/R2m) (mm) | −3.87 | −4.23 | −3.43 | −3.28 | −3.45 |
| f12e × | 14.55 | 15.92 | 12.93 | 12.35 | 13.10 |
| (f1m/CT1m) (mm) | | | | | |
| (CT1e + CT2e)/f | 0.73 | 0.87 | 0.48 | 0.67 | 1.31 |
| (R1e − R2e)/(R1e + R2e) | 0.72 | 1.01 | −1.91 | −0.99 | 0.28 |
| f × (V2e/V1e) (mm) | 0.63 | 0.69 | 0.56 | 0.54 | 0.57 |
| TDe/(CTR + CTQ) | 2.97 | 3.79 | 1.83 | 2.31 | 4.40 |
| f1e/\|R1e\| | 0.316 | 0.005 | 1.363 | 1.792 | 1.089 |
| f12e/CTQ | 6.72 | 7.35 | 5.97 | 5.70 | 6.05 |

The foregoing is only a description for the preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. A visual optical system, comprising a first optical system and a second optical system sequentially from a first side to a second side;
the first optical system comprising, sequentially from the first side to the second side along a first optical axis, a reflective polarizing element, a quarter wave plate and a first lens piece; wherein, the first lens piece has a positive refractive power, a first-side surface of the first lens piece is a concave surface, and a second-side surface of the first lens piece is a convex surface;
the second optical system comprising, sequentially from the first side to the second side along a second optical axis, a first lens having a positive refractive power and a second lens having a refractive power; wherein, a first-side surface of the second lens is a concave surface;
a number of lenses having refractive powers in the second optical system is two;
a radius of curvature R1m of the first-side surface of the first lens piece, a radius of curvature R2m of the second-side surface of the first lens piece, a combined focal length f12e of the first lens and the second lens, and a distance TDe on the second optical axis from a first-side surface of the first lens to a second-side surface of the second lens satisfy: 0.8<(R1m/R2m)/(f12e/TDe)<2.0.

2. The visual optical system according to claim 1, wherein a center thickness CT2e of the second lens on the second optical axis and a radius of curvature R3e of the first-side surface of the second lens satisfy: −1.25<CT2e/R3e<−0.15.

3. The visual optical system according to claim 1, wherein an effective focal length f1e of the first lens and an effective focal length f2e of the second lens satisfy:
−1.1≤(f1e+f2e)/(f1e−f2e)≤2.0.

4. The visual optical system according to claim 1, wherein a radius of curvature R1e of the first-side surface of the first lens and a radius of curvature R2e of a second-side surface of the first lens satisfy: −1.95<(R1e−R2e)/(R1e+R2e)<1.05.

5. The visual optical system according to claim 1, wherein an effective focal length f1e of the first lens and a radius of curvature R1e of the first-side surface of the first lens satisfy: 0<f1e/|R1e|<1.8.

6. The visual optical system according to claim 1, wherein a total effective focal length f of the visual optical system, a refractive index N1e of the first lens, and a refractive index N1m of the first lens piece satisfy: 0.5 mm<f×(N1e/N1m)<0.75 mm.

7. The visual optical system according to claim 1, wherein a center thickness CT1m of the first lens piece on the first optical axis, a center thickness CTR of the reflective polarizing element on the first optical axis, a center thickness CTQ of the quarter wave plate on the first optical axis, and a total effective focal length f of the visual optical system satisfy: 18.85<(CT1m+CTR+CTQ)/f<24.4.

8. The visual optical system according to claim 1, wherein a total effective focal length f of the visual optical system and the effective focal length f1e of the first lens satisfy: 0.15<f/f1e<1.35.

9. The visual optical system according to claim 1, wherein the combined focal length f12e of the first lens and the second lens, a combined focal length fzm of the reflective polarizing element, the quarter wave plate and the first lens piece, and the radius of curvature R2m of the second-side surface of the first lens piece, satisfy:
−4.25 mm<f12e×(fzm/R2m)<−3.25 mm.

10. The visual optical system according to claim 1, wherein the combined focal length f12e of the first lens and the second lens, an effective focal length f1m of the first lens piece, and a center thickness CT1m of the first lens piece on the first optical axis, satisfy: 12.3 mm<f12e×(f1m/CT1m)<15.95 mm.

11. The visual optical system according to claim 1, wherein a center thickness CT1e of the first lens on the second optical axis, the center thickness CT2e of the second lens on the second optical axis, and a total effective focal length f of the visual optical system, satisfy: 0.45<(CT1e+CT2e)/f<1.35.

12. The visual optical system according to claim 1, wherein a total effective focal length f of the visual optical system, an Abbe number V2e of the second lens, and an Abbe number V1e of the first lens, satisfy: 0.5 mm<f×(V2e/V1e)<0.7 mm.

13. The visual optical system according to claim 1, wherein the distance TDe on the second optical axis from the first-side surface of the first lens to the second-side surface of the second lens, a center thickness CTR of the reflective polarizing element on the first optical axis, and a center thickness CTQ of the quarter wave plate on the first optical axis, satisfy: 1.8<TDe/(CTR+CTQ)<4.45.

14. The visual optical system according to claim 1, wherein the combined focal length f12e of the first lens and the second lens, and a center thickness CTQ of the quarter wave plate on the first optical axis, satisfy: 5.65<f12e/CTQ<7.4.

15. The visual optical system according to claim 1, wherein an angle θ between the second optical axis and the first optical axis satisfies: 0°<θ<90°.
